(19) United States
(12) Patent Application Publication
(10) Pub. No.: US 2010/0031508 A1
(43) Pub. Date: Feb. 11, 2010

(54) ONE-PIECE WHEEL PRODUCED BY CASTING A WHEEL HUB AND SPIN-FORMING RIMS

(76) Inventors: Peio Todorov Stoyanov, Woodland Hills, CA (US); Ching-Lung Wang, Taipei (TW)

Correspondence Address: INTELLECTUAL PROPERTY DEVELOPMENT;JACK IVAN J'MAEV, 14175 TELEPHONE AVE., SUITE L, CHINO, CA, 91710, US

(21) Appl. No.: 12/450,292

(22) PCT Filed: Apr. 6, 2007
(86) PCT No.: PCT/US07/08645

§ 371 Date: Sep. 19, 2009

Related U.S. Application Data
(60) Provisional application No. 60/790,508, filed on Apr. 7, 2006.

(51) Int. Cl. B23P 17/00

(52) U.S. Cl. 29/894.325

(57) ABSTRACT

Method and apparatus for forming a wheel hub by means of a casting process which involves providing additional material during the casting process at the perimeter of the hub in quantity sufficient to form a rim; spin-forming a rim about the hub using the additional material provided during the casting process; machining mounting features in the hub; and machining finish features into the rim.

### BACKGROUND

Alloy wheels are often manufactured using a two-step process. In a first step, a wheel hub is formed using a casting process. Up until now, the rims of a wheel have not been produced using a casting process because such a casting process is not very useful when manufacturing a large, circular form that is open in the center. As a result, the rims of an alloy wheel are typically spin-formed as a structure that is separate and distinct from the hub of the wheel. The two portions are then combined to form a two-piece wheel assembly.

### BRIEF DESCRIPTION OF THE DRAWINGS

Several alternative embodiments will hereinafter be described in conjunction with the appended drawings and figures, wherein like numerals denote like elements, and in which:

FIG. 1 is a flow diagram that depicts one example method for manufacturing a one-peace wheel;

FIG. 2 is a flow diagram that depicts alternative example methods for casting a wheel hub;

FIG. 3 is a flow diagram that depicts one example method for spin-forming a rim which is integral with a wheel hub;

FIG. 4 depicts alternative method for spin-forming a rim wherein heat is used to make the material more ductile; and

FIGS. 5-9 are pictorial cross-section diagrams that depict a one-peace wheel at various stages in the manufacturing process commensurate with the manufacturing method herein described.

### DETAILED DESCRIPTION

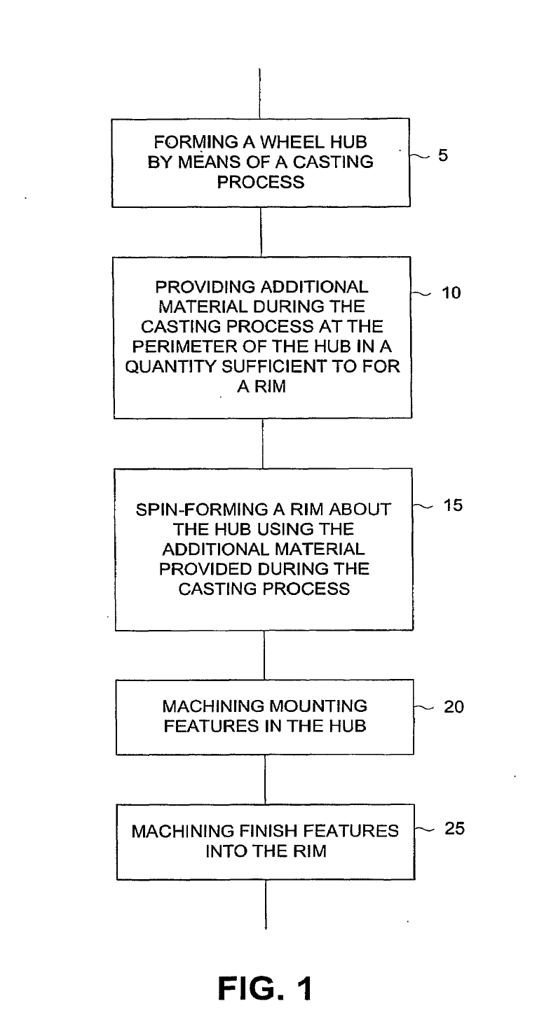

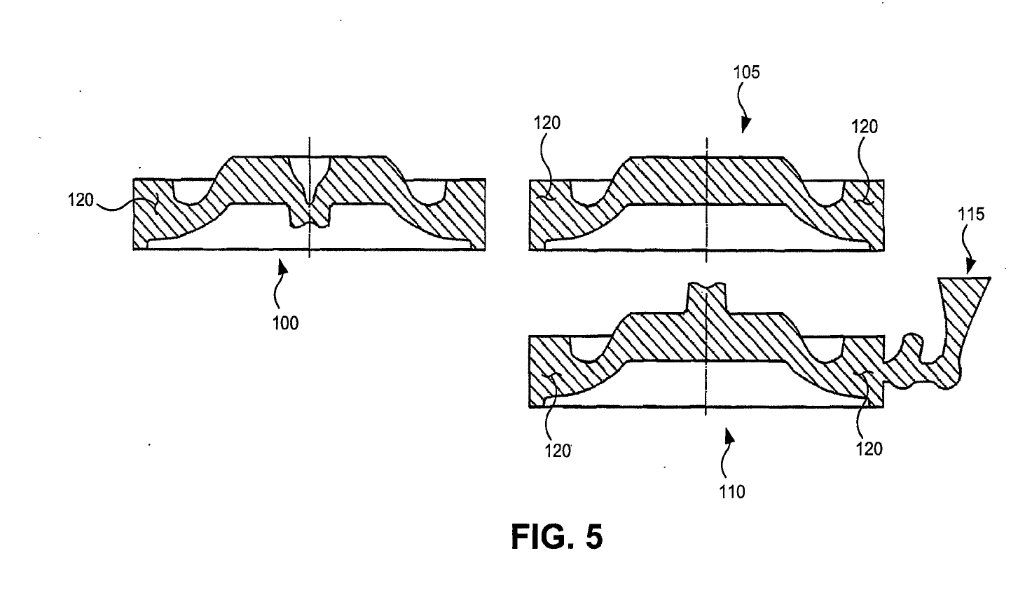

FIG. 1 is a flow diagram that depicts one example method for manufacturing a one-peace wheel. FIGS. 5-9 are pictorial cross-section diagrams that depict a one-peace wheel at various stages in the manufacturing process commensurate with the manufacturing method herein described. According to one illustrative manufacturing method, a one-peace wheel is fabricated by forming a wheel hub by means of a casting process (step 5). During the casting process, additional material is provided in substantially proximate to the perimeter of the hub (step 10). It should be appreciated that the additional material provided will be used in to spin-form a rim that is integral with the hub (step 15). Accordingly, the amount of material provided during the casting process should be in an amount sufficient to form the wheel rim. Once the rim is spin-formed from the additional material provided substantially proximate to the perimeter of the hub, an alternative example method provides for machining mounting features into the hub (step 20). Yet another alternative example method provides for machining finish features into the rim (step 25).

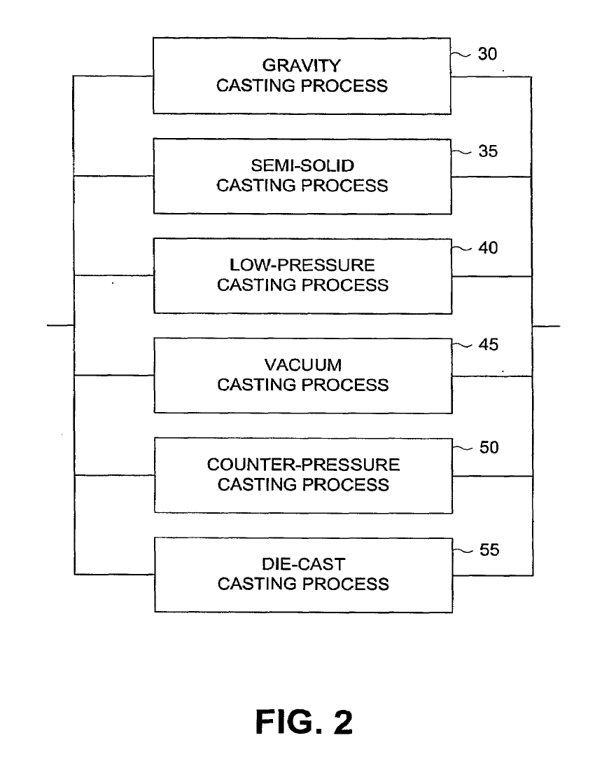

FIG. 2 is a flow diagram that depicts alternative example methods for casting a wheel hub. FIG. 5 depicts a wheel hub that is formed using alternative example methods for casting. According to one example method, a gravity casting process (step 30) is used to form of a wheel hub as depicted in a feature 110. In this case, material is allowed to flow 115 into a mold until the mold is filled. In yet another alternative method, a semi-solid casting process is used (step 35) to form a wheel hub. In yet another alternative method, a low-pressure casting process is used to form a wheel hub (step 40). A vacuum casting process (step 45) is used to form a wheel hub in an alternative example method. A counter-pressure casting process (step 50) is utilized in yet another alternative method for forming a wheel hub by means of a casting process. A die-cast casting process is used in yet another alternative method for forming a wheel hub (step 55). In each of these alternative example methods, additional material is provided in a sufficient quantity to form a rim, wherein such additional material 120 is proximate to the perimeter of the wheel hub.

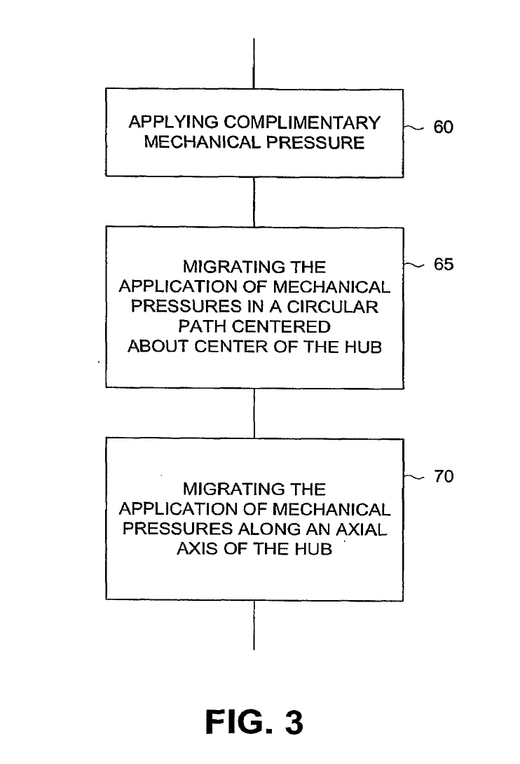

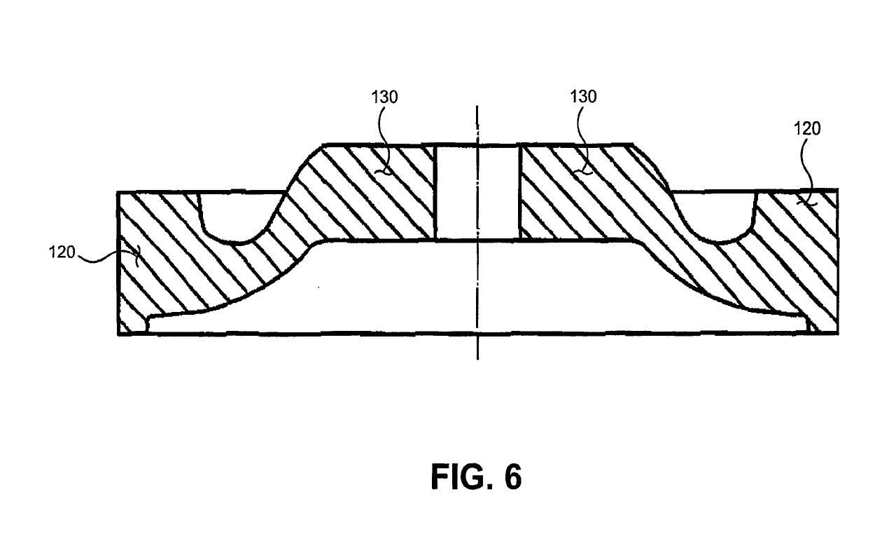

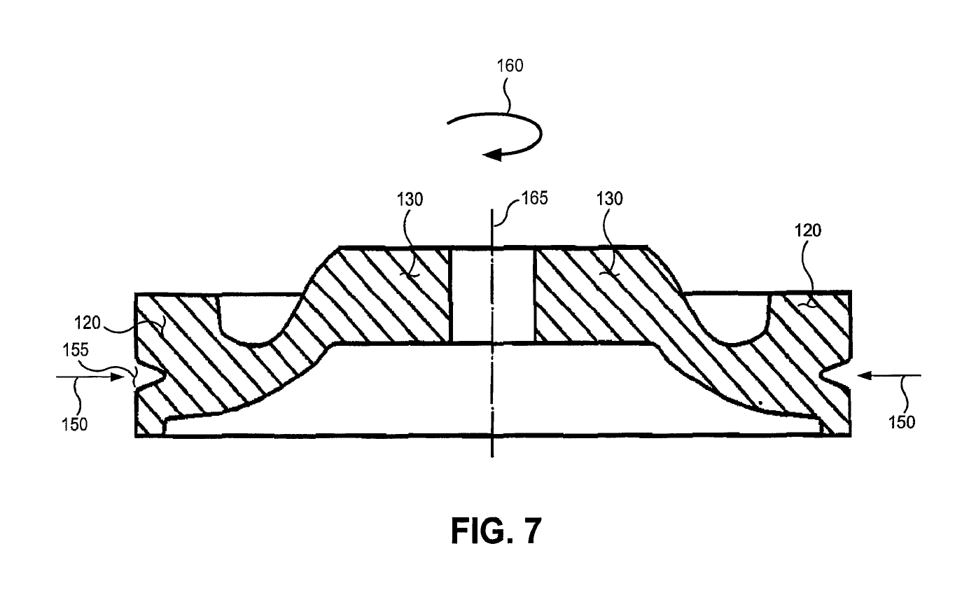

FIG. 3 is a flow diagram that depicts one example method for spin-forming a rim which is integral with a wheel hub. FIG. 6 depicts a wheel hub 130 that includes additional material 120 which is used to spin-form a rim. FIG. 7 depicts the wheel hub 130 during an initial phase where pressure 150 is applied to the additional material 120 so as to introduce a divot 155 around the perimeter of the additional material 120. It should be appreciated that the pressure 150 is applied while the wheel hub 130 is spinning 160 about its axis 165. It should likewise be appreciated that in an alternative method the wheel hub 130 is fixed and the application of pressure 150 is rotated about the axis 165. In either these alternative example methods, the effect is to migrate the application of mechanical pressure in a circular path about the center of the hub (step 65).

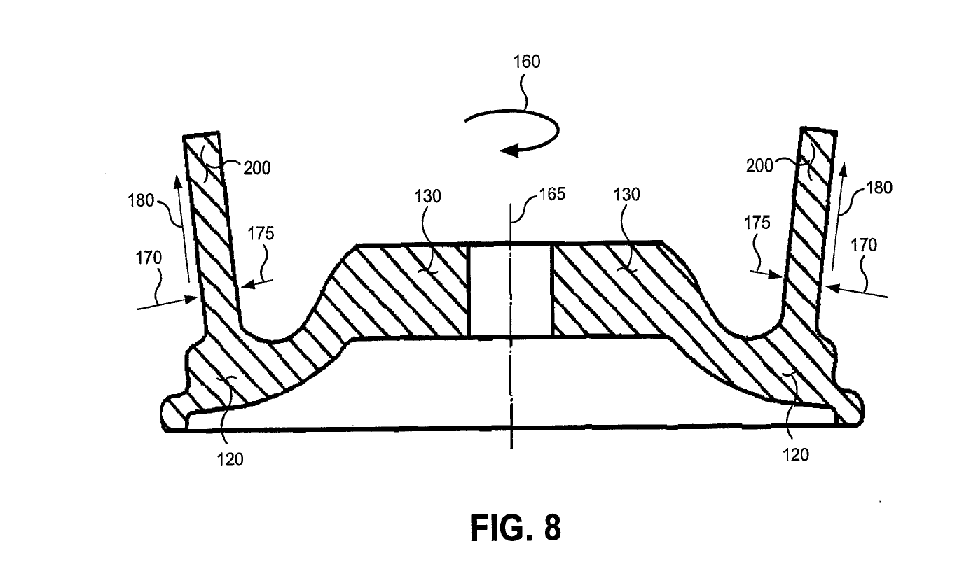

FIG. 8 depicts a later phase in a manufacturing process wherein complimentary pressures (170, 175) are applied to do the additional material provided during the casting process (step 60). It should be appreciated that these complimentary pressures are applied substantially outward 175 from the center axis 165 and substantially inward 170 toward the center axis 165 of the wheel hub 120. These complimentary pressures are applied in a path this circular (step 65) that is centered substantially about the center axis 165 of the wheel hub 120. Once the complimentary mechanical pressures complete the circular path about the center axis 165, they are migrated upward (step 70) 180 substantially in line with the axis 165 of the wheel hub 120. It should be appreciated that a tapering effect is realized thereby forming a rim from the additional material 120 provided during the casting process. It should also be appreciated that, according to one variation in this manufacturing method, that application of the complimentary pressures is applied in a spiral path about the center axis 165.

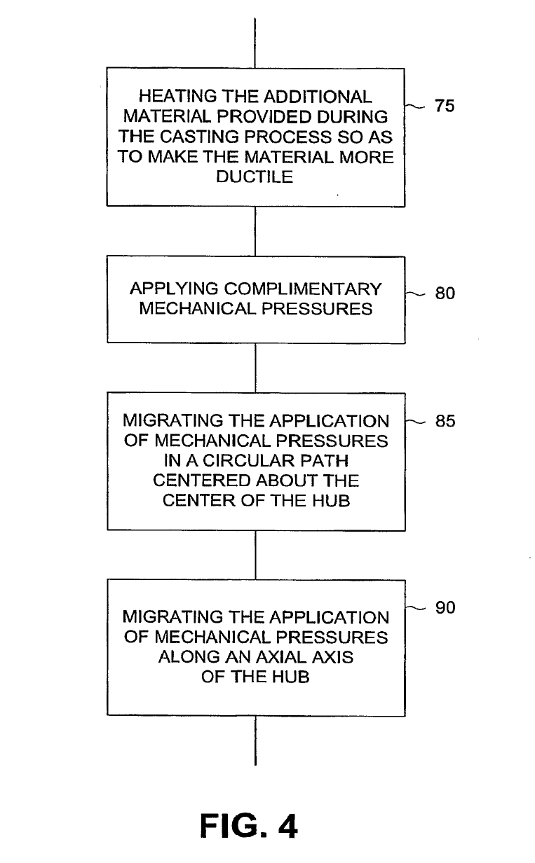

FIG. 4 depicts alternative method for spin-forming a rim wherein heat is used to make the material more ductile. In this alternative method, a rim that is spin-formed by applying heat (step 75) to the additional material provided during the casting of the hub. Typically, heat is applied prior to spinning, but this is only one alternative variation of the present method. The complimentary mechanical pressures are then applied (step 80) and migrated in a circular path about the center of the hub (step 85) and then migrated along the axial axis of the hub (step 90) as heretofore described.

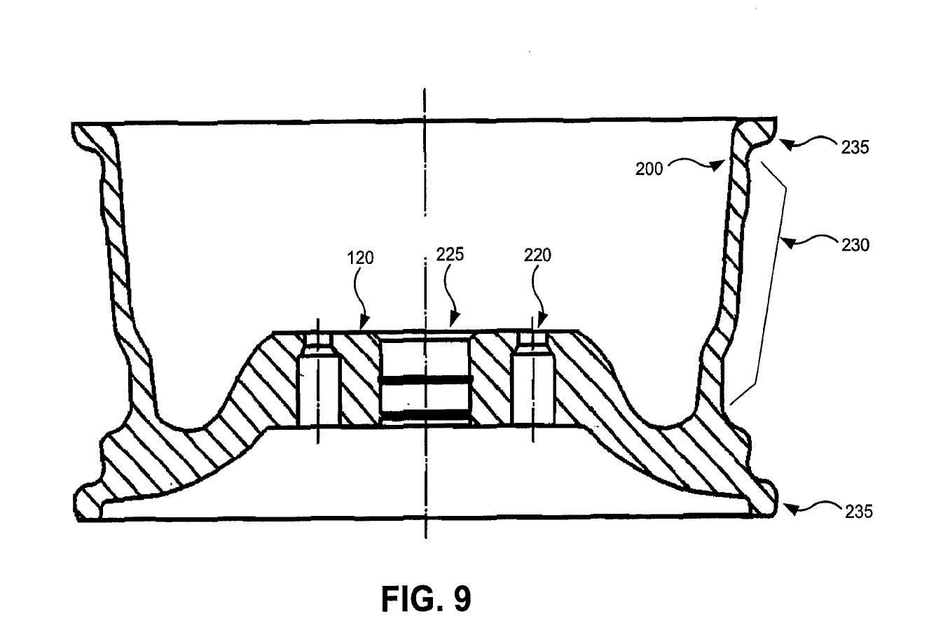

FIG. 9 is a pictorial diagram that that holds depicts an optional step wherein hub mounting features, for example holes for lug bolts 220 and a center axis hole 225, are machined into the wheel hub 120. In yet another example variation of the present method, additional features 230 are machined into the rim of 200 that is integral with the hub 120. One example of a rim feature includes a lip 235 for mounting of a tire on to the one-piece wheel.

In a wheel manufactured according to this process, a self-hardening aluminum alloy is used in one preferred embodiment. In one alternative embodiment, a 6000 series alloy is used (e.g. a “6061” aluminum alloy) is used when casting the wheel hub and when providing additional material that is used in a subsequent spin-forming process to for the rim of the wheel.

While the present method and apparatus has been described in terms of several alternative and exemplary embodiments, it is contemplated that alternatives, modifications, permutations, and equivalents thereof will become apparent to those skilled in the art upon a reading of the specification and study of the drawings. It is therefore intended that the true spirit and scope of the claims appended hereto include all such alternatives, modifications, permutations, and equivalents.

What is claimed is:

1. A one-piece wheel produced by a method comprising:
forming a wheel hub by means of a casting process;
providing additional material during the casting process at the perimeter of the hub in quantity sufficient to form a rim;
spin-forming a rim about the hub using the additional material provided during the casting process;
machining mounting features in the hub; and
machining finish features into the rim.

2. The one-piece wheel of claim 1 wherein the wheel hub is formed using at least one of a gravity casting process, semi-solid casting process, low-pressure casting process, vacuum casting process, counter-pressure casting process and a die-cast casting process.

3. The one-piece wheel of claim 1 wherein spin-forming a rim comprises:
applying complimentary mechanical pressures to at least one region of the additional material provided during the casting process;
migrating the application of the complimentary mechanical pressures is a substantially circular path centered substantially about the center of the wheel hub; and
migrating the application of the complimentary mechanical pressures in a path substantially parallel to an axial axis of the wheel hub.

4. The one-piece wheel of claim 1 wherein spin-forming a rim comprises:
heating the additional material provided during the casting process so as to make the material more ductile;
applying complimentary mechanical pressures to at least one region of the additional material provided during the casting process;
migrating the application of the complimentary mechanical pressures is a substantially circular path centered substantially about the center of the wheel hub; and
migrating the application of the complimentary mechanical pressures in a path substantially parallel to an axial axis of the wheel hub.

5. The one-piece wheel of claim 1 wherein the wheel hub and the additional material provided during the casting process comprises aluminum substantially comprises a self-hardening aluminum alloy.

6. The one-piece wheel of claim 1 wherein the wheel hub and the additional material provided during the casting process comprises aluminum substantially comprises of 6000 series alloy.

7. A method for fabricating a one-piece wheel comprising:
forming a wheel hub by means of a casting process;
providing additional material during the casting process at the perimeter of the hub in quantity sufficient to form a rim;
spin-forming a rim about the hub using the additional material provided during the casting process;
machining mounting features in the hub; and
machining finish features into the rim.

8. The method of claim 7 wherein the wheel hub is formed using at least one of a gravity casting process, semi-solid casting process, low-pressure casting process, vacuum casting process, counter-pressure casting process and a die-cast casting process.

9. The method of claim 7 wherein spin-forming a rim comprises:
applying complimentary mechanical pressures to at least one region of the additional material provided during the casting process;
migrating the application of the complimentary mechanical pressures is a substantially circular path centered substantially about the center of the wheel hub; and
migrating the application of the complimentary mechanical pressures in a path substantially parallel to an axial axis of the wheel hub.

10. The method of claim 7 wherein spin-forming a rim comprises:
heating the additional material provided during the casting process so as to make the material more ductile;
applying complimentary mechanical pressures to at least one region of the additional material provided during the casting process;
migrating the application of the complimentary mechanical pressures is a substantially circular path centered substantially about the center of the wheel hub; and
migrating the application of the complimentary mechanical pressures in a path substantially parallel to an axial axis of the wheel hub.

11. The method of claim 7 wherein the wheel hub and the additional material provided during the casting process comprises aluminum substantially comprises a self-hardening aluminum alloy.

12. The method of claim 7 wherein the wheel hub and the additional material provided during the casting process comprises aluminum substantially comprised of a 6000 series alloy.
